(19) United States
(12) Patent Application Publication
(10) Pub. No.: US 2013/0187533 A1
(43) Pub. Date: Jul. 25, 2013

(54) PLASMA DISPLAY PANEL AND METHOD FOR PRODUCING THE SAME

(71) Applicants: Toru Nakajima, Osaka (JP); Kentaro Ueda, Osaka (JP); Hiroshi Kobayashi, Osaka (JP); Nobuyuki Seto, Osaka (JP)

(72) Inventors: Toru Nakajima, Osaka (JP); Kentaro Ueda, Osaka (JP); Hiroshi Kobayashi, Osaka (JP); Nobuyuki Seto, Osaka (JP)

(73) Assignee: PANASONIC CORPORATION, Osaka (JP)

(21) Appl. No.: 13/641,628

(22) PCT Filed: Mar. 5, 2012
(86) PCT No.: PCT/JP2012/001482

§ 371 Date: Dec. 12, 2012

(30) Foreign Application Priority Data
Jun. 15, 2011 (JP) 2011-132969

(51) Int. Cl. H01J 9/18

(52) U.S. Cl. CPC H01J 9/18
USPC 313/491; 445/24

(57) ABSTRACT

A method for producing a plasma display panel includes steps of forming a bus electrode by separately exposing two regions such as a first electrode region, and a second electrode region divided at a center of a front substrate, forming a barrier rib by separately exposing two regions such as a first barrier rib region, and a second barrier rib region divided at a center of a rear substrate, finding an aperture ratio of the first electrode region and an aperture ratio of the second electrode region in a vicinity of a boundary between the first electrode region and the second electrode region, and finding an aperture ratio of the first barrier rib region and the aperture ratio of the second barrier rib region in a vicinity of a boundary between the first barrier rib region and the second barrier rib region.

### TECHNICAL FIELD

A technique disclosed here relates to a plasma display panel used in a display device and a method for producing the same.

### BACKGROUND ART

It is known that a photolithography method is used in producing a plasma display panel (hereinafter, referred to as a PDP). In addition, in a case where a substrate size is large, a separate exposing method in which an exposure region is divided into a plurality of regions to be exposed is used (refer to PTL 1, for example).

### CITATION LIST

### Patent Literature

PTL 1: Unexamined Japanese Patent Publication No. 2007-200879

### SUMMARY OF THE INVENTION

A method for producing a PDP includes steps of forming a bus electrode by separately exposing an electrode paste layer provided on a front substrate and containing a photosensitive component, in two regions such as a first electrode region, and a second electrode region divided at a center of the front substrate, forming a barrier rib by separately exposing a barrier rib paste layer provided on a rear substrate and containing a photosensitive component, in two regions such as a first barrier rib region, and a second barrier rib region divided at a center of the rear substrate, finding an aperture ratio of the first electrode region and an aperture ratio of the second electrode region in a vicinity of a boundary between the first electrode region and the second electrode region, finding an aperture ratio of the first barrier rib region and an aperture ratio of the second barrier rib region in a vicinity of a boundary between the first barrier rib region and the second barrier rib region, finding a first difference value by subtracting a value obtained by multiplying the aperture ratio of the second electrode region by the aperture ratio of the second barrier rib region, from a value obtained by multiplying the aperture ratio of the first electrode region by the aperture ratio of the first barrier rib region, in a case where the first electrode region and the first barrier rib region are disposed so as to confront each other, finding a second difference value by subtracting a value obtained by multiplying the aperture ratio of the second electrode region by the aperture ratio of the first barrier rib region, from a value obtained by multiplying the aperture ratio of the first electrode region by the aperture ratio of the second barrier rib region, in a case where the first electrode region and the second barrier rib region are disposed so as to confront each other, disposing the first electrode region and the first barrier rib region so as to confront each other, in a case where an absolute value of the first difference value is smaller than an absolute value of the second difference value, and disposing the first electrode region and the second barrier rib region so as to confront each other in a case where the absolute value of the first difference value is greater than the absolute value of the second difference value.

A PDP is produced by a producing method including steps of forming a bus electrode by separately exposing an electrode paste layer provided on a front substrate and containing a photosensitive component, in two regions such as a first electrode region, and a second electrode region divided at a center of the front substrate, forming a barrier rib by separately exposing a barrier rib paste layer provided on a rear substrate and containing a photosensitive component, in two regions such as a first barrier rib region, and a second barrier rib region divided at a center of the rear substrate, finding an aperture ratio of the first electrode region and an aperture ratio of the second electrode region in a vicinity of a boundary between the first electrode region and the second electrode region, finding an aperture ratio of the first barrier rib region and an aperture ratio of the second barrier rib region in a vicinity of a boundary between the first barrier rib region and the second barrier rib region, finding a first difference value by subtracting a value obtained by multiplying the aperture ratio of the second electrode region by the aperture ratio of the second barrier rib region, from a value obtained by multiplying the aperture ratio of the first electrode region by the aperture ratio of the first barrier rib region, in a case where the first electrode region and the first barrier rib region are disposed so as to confront each other, finding a second difference value by subtracting a value obtained by multiplying the aperture ratio of the second electrode region by the aperture ratio of the first barrier rib region, from a value obtained by multiplying the aperture ratio of the first electrode region by the aperture ratio of the second barrier rib region, in a case where the first electrode region and the second barrier rib region are disposed so as to confront each other, disposing the first electrode region and the first barrier rib region so as to confront each other, in a case where an absolute value of the first difference value is smaller than an absolute value of the second difference value, and disposing the first electrode region and the second barrier rib region so as to confront each other in a case where the absolute value of the first difference value is greater than the absolute value of the second difference value.

### BRIEF DESCRIPTION OF DRAWINGS

FIG. 1 is a perspective view showing a schematic structure of a PDP.

FIG. 2 is a schematic view showing a discharge cell structure of the PDP.

FIG. 3 is a view showing a state in which a left region of a substrate is exposed, in separate exposure according to present exemplary embodiment.

FIG. 4 is a cross-sectional view taken along line 4-4 in FIG. 3.

FIG. 5 is a view showing a state in which a right region of the substrate is exposed, in the separate exposure according to present exemplary embodiment.

FIG. 6 is a cross-sectional view taken along line 6-6 in FIG. 5.

FIG. 7 is a view showing a part of a flow for producing the PDP according to present exemplary embodiment.

FIG. 8 is a view of a front substrate according to present exemplary embodiment taken from a side on which a bus electrode is formed.

FIG. 9 is a view of a rear substrate according to present exemplary embodiment taken from a side on which a vertical barrier rib is formed.

FIG. 10 is a view showing a state in which region A of the front substrate and region A of the rear substrate are disposed so as to confront each other.

FIG. 11 is an enlarged view of a vicinity of a connection part in FIG. 10.

FIG. 12 is a view showing a state in which region A of the front substrate and region B of the rear substrate are disposed so as to confront each other.

FIG. 13 is an enlarged view of a vicinity of a connection part in FIG. 12.

FIG. 14 is a view showing a measurement result of line width difference of the bus electrode and the barrier rib.

FIG. 15 is a view showing a calculated value and an actual measured value of brightness differences in a case where a front plate and a rear plate shown in FIG. 14 are used.

### DESCRIPTION OF EMBODIMENTS

### 1. Configuration of PDP 100

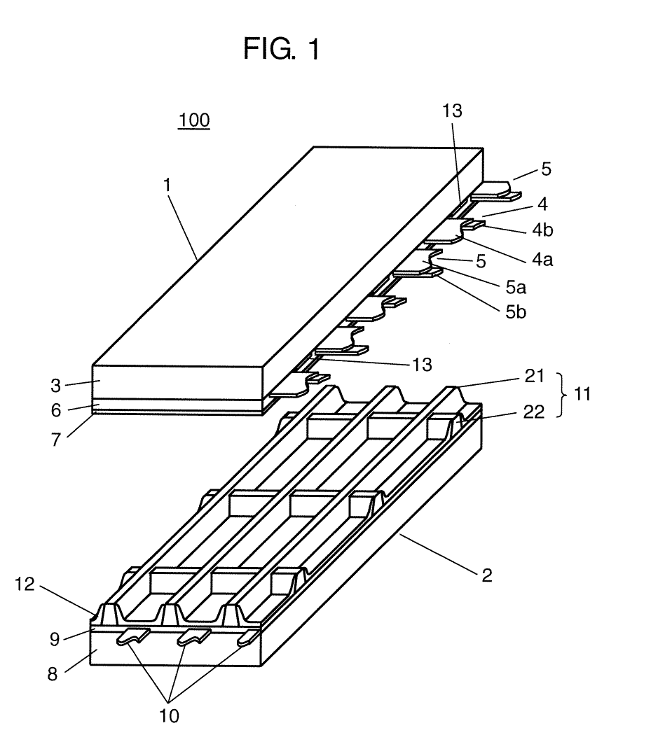

As shown in FIG. 1, PDP 100 is composed of front plate 1 and rear plate 2. Front plate 1 and rear plate 2 are disposed so as to confront each other. A discharge space is provided between front plate 1 and rear plate 2. A mixture gas of neon (Ne) and xenon (Xe) is enclosed in the discharge space as a discharge gas.

Front plate 1 has a plurality of scan electrodes 4 and a plurality of sustain electrodes 5 formed on glass front substrate 3. Scan electrode 4 and sustain electrode 5 are provided parallel to each other. In addition, dielectric layer 6 is provided on front substrate 3 so as to cover scan electrode 4 and sustain electrode 5. Protective layer 7 made of a magnesium oxide (MgO) is provided on dielectric layer 6. Scan electrode 4 has transparent electrode 4a and bus electrode 4b laminated on transparent electrode 4a. Sustain electrode 5 has transparent electrode 5a and bus electrode 5b laminated on transparent electrode 5a.

Rear plate 2 is provided with a plurality of data electrodes 10 formed on glass rear substrate 8. In addition, base dielectric layer 9 is provided on rear substrate 8 so as to cover data electrode 10. A plurality of barrier ribs 11 is provided on base dielectric layer 9 to divide the discharge space. For example, barrier rib 11 is in a shape of a lattice having vertical barrier rib 21 and a horizontal barrier rib 22 perpendicular to vertical barrier rib 21. Phosphor layer 12 is provided between barrier ribs 11.

When PDP 100 is seen from a front, data electrode 10 intersects with scan electrode 4 and sustain electrode 5. A plurality of discharge cells is formed at intersection parts between scan electrodes 4 and sustain electrodes 5, and data electrodes 10. In addition, black light-blocking layer 13 may be provided between scan electrode 4 and sustain electrode 5 to improve contrast.

In addition, PDP 100 is not limited to the above configuration. For example, stripe-shaped barrier rib 11 may be formed. In addition, FIG. 1 shows the example in which scan electrode 4 and sustain electrode 5 are alternately arranged. However, the electrodes may be arranged such that scan electrode 4, sustain electrode 5, sustain electrode 5, and scan electrode 4 are arranged in this order.

### 2. Method for Producing PDP 100

### 2-1. Method for Producing Front Plate 1

Scan electrode 4 and sustain electrode 5 are formed on front substrate 3 by a photolithography method. A detail will be described later.

Then, dielectric layer 6 is formed. A material of dielectric layer 6 includes a dielectric paste containing a dielectric glass frit, a resin, and a solvent. First, the dielectric paste is applied by a die coating method to front substrate 3 so as to cover scan electrode 4 and sustain electrode 5 with a predetermined thickness. Then, the solvent in the dielectric paste is removed in a baking oven. Finally, the dielectric paste is fired at a predetermined temperature in the baking oven. That is, the resin in the dielectric paste is removed. In addition, the dielectric glass frit is softened. The softened dielectric glass frit is hardened again after fired. Through the above steps, dielectric layer 6 is formed. Here, other than the method in which the dielectric paste is applied by the die coating method, a screen printing method, or a spin coating method may be used. In addition, instead of using the dielectric paste, a film serving as dielectric layer 6 may be formed by a CVD (Chemical Vapor Deposition) method and the like.

Then, protective layer 7 made of the magnesium oxide (MgO) is formed on dielectric layer 6. Protective layer 7 is formed in an EB (Electron Beam) deposition apparatus, as one example. A material of protective layer 7 includes a pellet composed of a single crystal MgO. In addition, aluminum (Al), silicon (Si), and the like may be added to the pellet as impurities.

First, the pellet arranged in a film-forming chamber in the EB deposition apparatus is irradiated with an electron beam. The pellet is evaporated by energy of the electron beam. The evaporated MgO is attached on dielectric layer 6 arranged in the film-forming chamber. A film thickness of the MgO is adjusted so as to fit in a predetermined range by intensity of the electron beam and pressure in the film-forming chamber.

In addition, protective layer 7 may include a mixed film with a calcium oxide (CaO), or a film containing a metal oxide such as a strontium oxide (SrO), barium oxide (BaO), or aluminum oxide (Al₂O₃), other than the MgO. In addition, a film containing several kinds of metal oxides may be used.

Through the above steps, front plate 1 having scan electrode 4, sustain electrode 5, dielectric layer 6, and protective layer 7 on front substrate 3 is completed.

### 2-2. Method for Producing Rear Plate 2

As shown in FIG. 1, data electrode 10 is formed on rear substrate 8 by the photolithography method. A material of data electrode 10 includes a data electrode paste containing silver (Ag) to ensure conductivity, a glass frit to bind the silver, a photosensitive resin, a solvent, and the like. First, the data electrode paste is applied to rear substrate 8 so as to have a predetermined thickness by the screen printing method. Then, the solvent in the data electrode paste is removed in the baking oven. Then, the data electrode paste is exposed to light through a photomask having a predetermine pattern. Then, the data electrode paste is developed, and a data electrode pattern is formed. Finally, the data electrode pattern is fired at a predetermined temperature in the baking oven. That is, the photosensitive resin in the data electrode pattern is removed. In addition, the glass frit in the data electrode pattern is softened. The softened glass frit is hardened after fired. Through the above steps, data electrode 10 is formed. Here, other than the method in which the data electrode paste is applied by screen printing, a sputtering method or a deposition method may be used.

Then, base dielectric layer 9 is formed. A material of base dielectric layer 9 includes a base dielectric paste containing a glass frit, a resin, a solvent, and the like. First, the base dielectric paste is applied by the screen printing method to rear substrate 8 having data electrode 10 so as to cover data electrode 10 with a predetermined thickness. Then, the solvent in the base dielectric paste is removed in the baking oven. Finally, the base dielectric paste is fired at a predetermined temperature in the baking oven. That is, the resin in the base dielectric paste is removed. In addition, the glass frit is softened. The softened glass frit is hardened after fired. Through the above steps, base dielectric layer 9 is formed.

In addition, other than the method in which the base dielectric paste is applied by the screen printing, the die coating method, the spin coating method, or the like may be used. In addition, instead of using the base dielectric paste, a film serving as base dielectric layer 9 may be formed by the CVD (Chemical Vapor Deposition) method.

Then, barrier rib 11 is formed by the photolithography method. A detail will be described later.

Then, phosphor layer 12 is formed. A material of phosphor layer 12 includes a phosphor paste containing phosphor particles, a binder, a solvent and the like. First, the phosphor paste is applied by a dispensing method to base dielectric layer 9 provided between adjacent barrier ribs 11, and to a side surface of barrier rib 11 so as to have a predetermined thickness. Then, the solvent in the phosphor paste is removed in the baking oven. Finally, the phosphor paste is fired at a predetermined temperature in the baking oven. That is, the resin in the phosphor paste is removed. Through the above steps, phosphor layer 12 is formed. In addition, other than the dispensing method, the screen printing method may be used.

Through the above steps, rear plate 2 having data electrode 10, base dielectric layer 9, barrier rib 11, and phosphor layer 12 on rear substrate 8 is completed.

### 2-3. Method for Assembling Front Plate 1 and Rear Plate 2

First, a sealing material is provided in a periphery of rear plate 2 by the dispensing method. A material of the sealing material includes a sealing paste containing a glass frit, a binder, a solvent, and the like. Then, the solvent in the sealing paste is removed in the baking oven. Then, front plate 1 and rear plate 2 are disposed so as to confront each other. Then, the peripheries of front plate 1 and rear plate 2 are sealed with the glass frit. Finally, the discharge gas containing Ne, Xe, and the like is enclosed in the discharge space.

### 3. Lithography Method

At the time of exposure, the photomask and the substrate to be exposed are aligned. When they are out of alignment, the pattern cannot be formed as designed. Thus, a display state changes in an image display region of PDP 100, or an outer appearance varies. Therefore, considerably high precision is required in the alignment. In tandem with development of a large screen of PDP 100, a separate exposure method using several photomasks is employed in order to expose a large region which is larger than an exposure region of the one photomask.

According to the separate exposure method, there is an overlapped region for connecting one separate exposure region and another separate exposure region (hereinafter, referred to as a connection region). Therefore, the one separate exposure region and the other separate exposure region also need to be aligned.

However, when the several photomasks are used, a phenomenon that a pattern width in the one separate exposure region is different from that in the other separate exposure region is generated in some cases due to an individual difference of the photomask, a difference in environmental temperature in an exposure apparatus, or a difference in gap between the photomask and the substrate.

### 3-1. Aperture Ratio of Discharge Cell

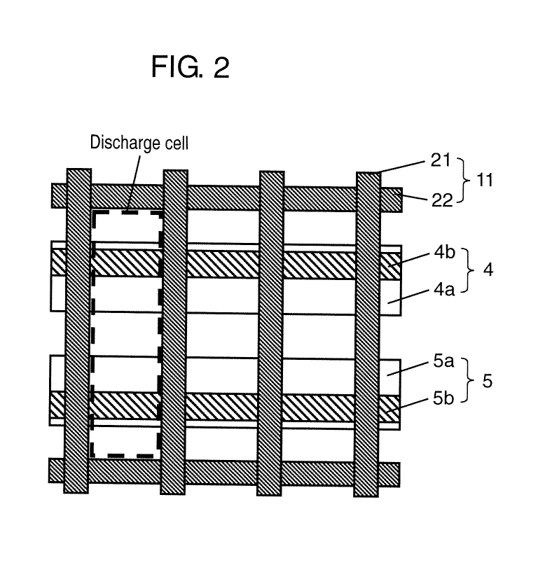

When the pattern width differs, an aperture ratio of the discharge cell changes. As shown in FIG. 2, the one discharge cell is a region surrounded by vertical barrier rib 21 and horizontal barrier rib 22. Visible light generated from the discharge cell passes through front plate 1. However, front plate 1 is provided with bus electrodes 4b and 5b which do not transmit the visible light. As widths of the bus electrodes 4b and 5b increase, the aperture ratio decreases, compared with an aperture ratio of a designed value in the one discharge cell. That is, a region which blocks the visible light beam increases. Therefore, light obtaining efficiency reduces. Thus, its brightness becomes low. Meanwhile, as the widths of bus electrodes 4b and 5b decrease, the brightness becomes high.

Similarly, as a width of barrier rib 11 increases, the aperture ratio decreases compared with the aperture ratio of the designed value in the one discharge cell. That is, the region which blocks the light increases. Therefore, light obtaining efficiency reduces. Thus, its brightness becomes low. Meanwhile, as the width of barrier rib 11 decreases, the brightness becomes high.

Therefore, a value obtained by multiplying the aperture ratio of front plate 1 by the aperture ratio of rear plate 2 is related to the light-obtaining efficiency. Thus, as the value obtained by multiplying the aperture ratio of front plate 1 by the aperture ratio of rear plate 2 increases, the brightness tends to become high. Meanwhile, as the value obtained by multiplying the aperture ratio of front plate 1 by the aperture ratio of rear plate 2 decreases, the brightness tends to become low.

In addition, an effect of the width change of vertical barrier rib 21 on the light-obtaining efficiency is greater than an effect of the width change of horizontal barrier rib 22 on the light-obtaining efficiency. This is because discharge is not substantially generated in a vicinity of horizontal barrier rib 22. That is, the visible light generated from the discharge cell is relatively weak in the vicinity of horizontal barrier rib 22.

When there is a difference in brightness between the one separate exposure region and the other separate exposure region, it becomes conspicuous in the vicinity of the connection region especially. When the difference in brightness is generated in the vicinity of the connection region, a viewer easily recognizes this in watching the PDP device. That is, there is a reduction in display quality of the PDP device when it is lit up.

### 3-2. Separate Exposure Method

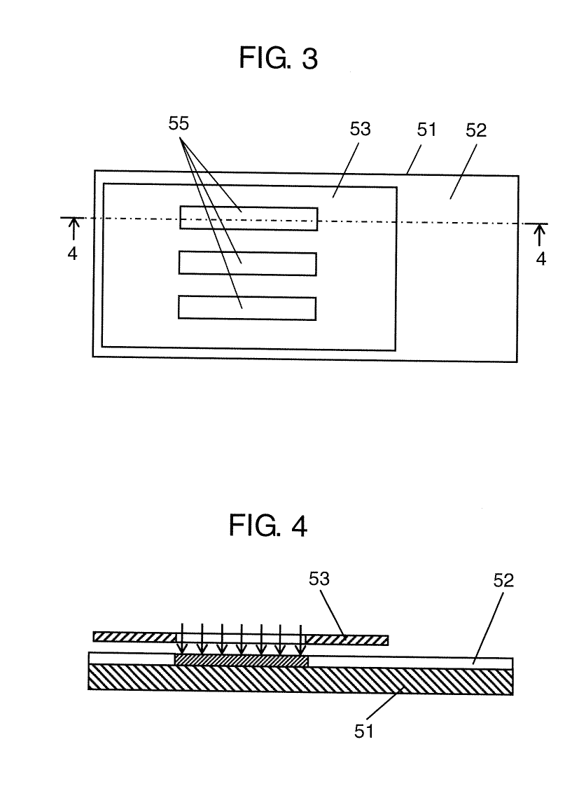

As shown in FIGS. 3 to 6, photosensitive material layer 52 is provided on rectangular substrate 51. First photomask 53 and second photomask 54 are disposed in positions opposed to substrate 51. First photomask 53 and second photomask 54 are rectangular in shape. In addition, the rectangular shape does not always mean a geometrically complete rectangular shape. It may be only roughly regarded as the rectangular shape by visual observation even when there is partially protruded or recessed for the reason of a design of the photomask.

An area of substrate 51 is larger than those of first photomask 53 and second photomask 54. Thus, photosensitive material layer 52 is separately exposed. That is, it is separated into a region exposed through first photomask 53 and a region exposed through second photomask 54.

According to present exemplary embodiment, first photomask 53 and second photomask 54 are disposed in the exposure apparatus. First photomask 53 and second photomask 54 are absorbed on photomask folders (not shown) in the exposure apparatus. The absorbed surface is provided in a region which is not interfered by the exposure region. A mechanism movable in three-dimensional directions is provided for each of first photomask 53 and second photomask 54, in the absorbed position. Thus, each of first photomask 53 and second photomask 54 can be moved and fixed independently.

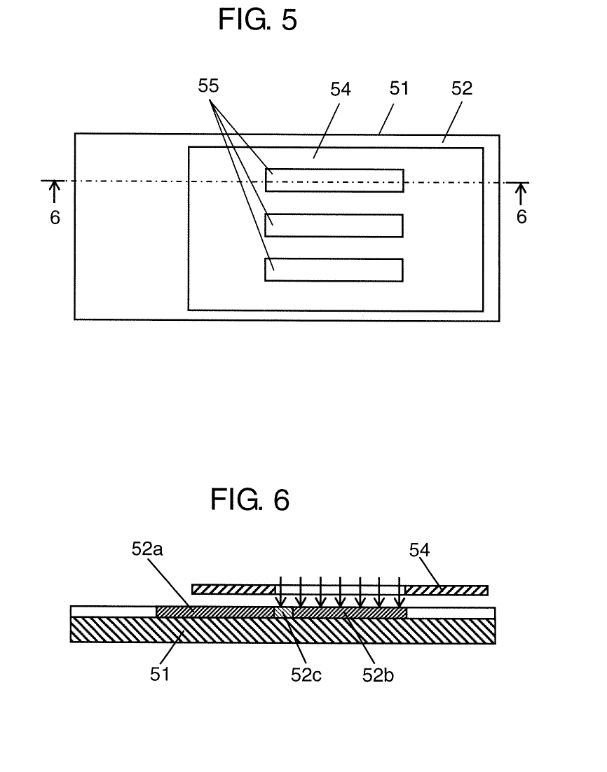

As shown in FIG. 3 and FIG. 4, on the left side of substrate 51, first photomask 53 is disposed over photosensitive material layer 52 with an exposure gap interposed therebetween. As shown in FIG. 3 and FIG. 5, each of first photomask 53 and second photomask 54 is provided with openings 55.

Light is emitted from an exposure light source (not shown) provided above first photomask 53 and second photomask 54 toward the photosensitive material layer 52 through openings 55. As shown in FIG. 6, first exposure region 52a is provided on a left side of connection part 52c serving as the connection region. Second exposure region 52b is provided on a right side of connection part 52c. In addition, according to present exemplary embodiment, a region which has not been exposed in photosensitive material layer 52 is removed in a developing step.

In addition, alignment marks are provided in upper and lower end parts and a center part of longer sides of substrate 51. When the alignment mark is used, substrate 51 and first photomask 53 and second photomask 54 are easily aligned. When the separate exposure method is applied to the production of PDP 100, an alignment mark of front plate 1 can be formed of an ITO at the same time as transparent electrodes 4a and 5a are formed on front substrate 3, as one example. An alignment mark of rear plate 2 can be formed of a conductive material such as Ag at the same time as data electrode 10 is formed on rear substrate 8.

### 4-1. Steps S11 to S14 of Forming Bus Electrodes 4b and 5b

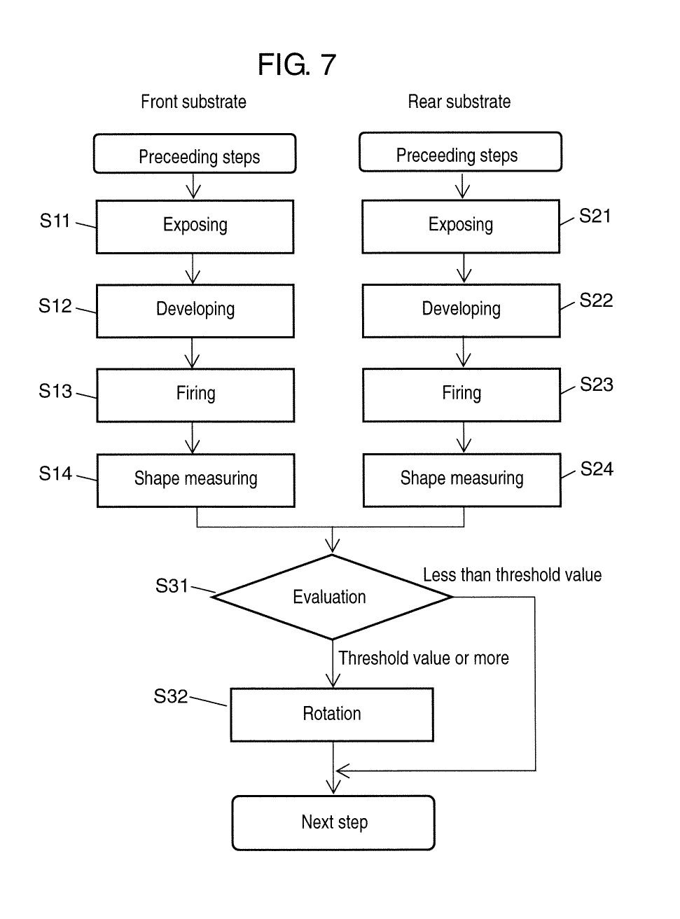

As shown in FIG. 7, steps of forming bus electrodes 4b and 5b include exposing step S11, developing step S12, firing step S13, and shape measuring step S14.

### (Application of Electrode Paste)

An electrode paste is applied to front substrate 3 by the screen printing method. A film thickness of the applied electrode paste is appropriately set within a range of 10 μm to 15 μm. Other than the screen printing method, the die coating method and the like may be used. In addition, other than the method in which the electrode paste is used, a conductive film may be patterned with a photoresist after formed by the sputtering method or the deposition method.

### (Electrode Paste)

The electrode paste contains a glass frit to bind a conductive particle and a conductive particle, a photosensitive monomer, a photopolymerization initiator, a resin, a solvent, and the like.

As the conductive particle, silver (Ag), copper (Cu), or the like is used. An average particle diameter of the conductive particle is preferably between 1 μm and 3 μm. When the average particle diameter is less than 1 gm, the particles likely to aggregate in the electrode paste. When the average particle diameter is more than 3 μm, the particles are hard to uniformly disperse in the electrode paste.

The glass frit contains at least 20% to 50% by weight of dibismuth trioxide (Bi₂O₃), 5% to 35% by weight of diboron trioxide (B₂O₃), 10% to 20% by weight of zinc oxide (ZnO), and 5% to 20% by weight of barium oxide (BaO). In addition, the glass frit may contain molybdenum trioxide (MoO₃), tungsten trioxide (WO₃), and the like.

When a content amount of Bi₂O₃ is too much, a heat expansion coefficient increases and a softening point becomes low, so that it is preferably set between 20% and 50% by weight. Furthermore, it is more preferably set between 30% and 45% by weight. A content amount of B₂O₃ to form a glass framework is preferably set between 5% and 35% by weight because when it is too much, the heat expansion coefficient decreases and the softening point becomes high.

A content amount of ZnO is preferably set between 10% and 20% by weight because when it is too much, the heat expansion coefficient increases and transparency is damaged.

A content amount of BaO is preferably set between 5% and 20% by weight because when it is too much, the softening point becomes high.

The photosensitive monomer includes 2-hydroxyethyl acrylate, 2-hydroxypropyl acrylate, diethylene glycol diacrylate, triethylene glycol diacrylate, and the like. Among them, one kind may be independently used. Alternatively, among them, two or more kinds may be mixed and used.

The photopolymerization initiator contains substituted or unsubstituted polycyclic quinone serving as a compound having two intramolecular rings in a conjugated carbocyclic ring. It includes 9, 10-anthraquinone, 2-methylanthraquinone, 2-ethylanthraquinone, 2-t-buthylanthraquinone, and octamethylanthraquinone.

As the resin, an acrylic-type polymer, a cellulose-type polymer, or the like is used. The acrylic-type polymer may include at least one kind selected from polybutyl acrylate, polymethacrylate, and the like. The cellulose-type polymer may include at least one kind selected from ethylcellulose, hydroxycellulose, and hydroxypropylcellulose.

The solvent includes a terpene group such as α-, β-, γ-terpineol, ethylene glycol monoalkyl ether group, ethylene glycol dialkyl ether group, diethylene glycol monoalkyl ether group, and diethylene glycol dialkyl ether group. Among them, one kind may be independently used. Alternatively, among them, two or more kinds may be mixed and used.

These materials are mixed and dispersed by a disperser such as a triple roll mill, ball mill, or sand mill, whereby the electrode paste is produced.

### (Drying of Electrode Paste)

Then, the solvent in the electrode paste is removed in the baking oven. The baking oven includes a heater heating oven, reduced-pressure baking oven, infrared baking oven, and the like. An atmosphere in the drying treatment may be the air or an inert gas. A drying temperature is about 80° C. to 200°. A drying time is about 3 min to 30 min. A film thickness of the electrode paste decreases through the drying treatment. The film thickness of the electrode paste after dried is appropriately set within a range of 4 μm to 8 μm. The drying temperature and the drying time are appropriately set according to a kind and an amount of the solvent contained in the electrode paste. The above steps are preceding steps in FIG. 7.

### (Exposing)

In S11, the separate exposure is performed. A negative type photomask is used in the exposure process. The exposure apparatus may include a stepper exposure apparatus, a proximity exposure apparatus, and the like. A light-emitting device includes an excimer lamp, a low-pressure mercury lamp, a high-pressure mercury lamp, and the like.

A first bus electrode region is exposed to light through a first photomask on which a predetermined pattern is formed. The first photomask corresponds to first photomask 53 in FIG. 4. The first bus electrode region corresponds to first exposure region 52a in FIG. 6. Then, a second bus electrode region is exposed to light through a second photomask on which a predetermined pattern is formed. The second photomask corresponds to second photomask 54 in FIG. 6. The second bus electrode region corresponds to second exposure region 52b in FIG. 6. A wavelength of the light is set such that the photopolymerization initiator contained in the electrode paste reacts. It is about 250 nm to 450 nm in general. The region irradiated with the light, in the electrode paste is hardened due to polymerization of polymerizable monomer.

### (Developing)

In S12, the electrode paste is developed. As a developing solution, an alkali developing solution is used, as one example. More specifically, it includes a sodium carbonate solution, potassium hydroxide solution, TMAH (tetramethyl ammonium hydroxide), and the like. When the developing solution is ejected to the electrode paste, the region irradiated with the light remains, and the region not irradiated with the light is removed. Finally, the region is cleaned by water to remove a stain and the like attached on front substrate 3.

### (Firing)

In S13, a bus electrode pattern is fired in the baking oven. As the baking oven, for example, the heater heating oven and the like is used. An atmosphere in the firing treatment preferably contains oxygen to bake the resin. That is, the atmosphere may be the air. The bus electrode pattern is fired at a predetermined temperature in the baking oven. That is, the photosensitive resin in the bus electrode pattern is removed. In addition, the glass frit in the bus electrode pattern is softened. The softened glass frit is hardened after fired. Through the firing treatment, bus electrodes 4b and 5b are formed on front substrate 3.

### (Shape Measuring)

In S14, for example, widths of bus electrodes 4b and 5b are measured by an image recognition device. The image recognition device includes a solid-state image sensing element, a camera having a lens, an illuminating device, and a computer. Line widths of the bus electrodes are measured by taking pictures of bus electrodes 4b and 5b, removing a noise, and performing an imaging process such as binarization. The line widths of the bus electrodes 4b and 5b are measured in each region of the first bus electrode region and the second bus electrode region. Especially, they are preferably measured in the vicinity of connection part 52c. In addition, they are preferably measured in several positions.

### 4-2. Steps S21 to S24 of Forming Barrier Rib 11

As shown in FIG. 7, steps of forming barrier rib 11 include exposing step S21, developing step S22, firing step S23, and shape measuring step S24.

### (Application of Barrier Rib Paste)

First, a barrier rib paste is applied to the insulating layer by the die coating method so as to have a predetermined thickness. A film thickness of the applied barrier rib paste is appropriately set within a range of about 100 μm to 300 μm. The application apparatus of the barrier rib paste may include a screen printer, die coater, blade coater, and the like. The applied thickness can be adjusted by the number of times of application, a screen printing mesh, a paste viscosity, and the like.

### (Barrier Rib Paste)

A material of the barrier rib includes the barrier rib paste containing filler, a glass frit to bind the filler, a photosensitive resin, and a solvent.

The photosensitive resin is a negative type. That is, the exposed part is more likely to be soluble in the developing solution.

The filler includes an oxide such as dialuminum trioxide (Al₂O₃), silicon dioxide (SiO₂), or cordierite, as one example.

The glass frit contains, as a main component, dibismuth trioxide (Bi₂O₃), diboron trioxide (B₂O₃), or divanadium pentoxide (V₂O₅). For example, it includes Bi₂O₃_{^{−}}B₂O₃_{^{−}}RO-MO based glass. Here, R is any one of barium (Ba), strontium (Sr), calcium (Ca), and magnesium (Mg). In addition, M is any one of copper (Cu), antimony (Sb), and iron (Fe). Other than the above, for example, it includes V₂O₅—BaO—TeO-WO based glass.

The photosensitive resin is preferably an alkali-soluble resin. When the photosensitive resin has an alkali-soluble property, an alkaline aqueous solution can be used as the developing solution instead of using an organic solvent which is problematic in terms of circumstances. The alkali-soluble resin is preferably an acrylic-type copolymer, as one example. The acrylic-type copolymer is a copolymer containing at least an acrylic-type monomer in the copolymer component.

Furthermore, the barrier rib paste may contain the polymerization initiator, and the organic solvent, and may further contain, when needed, non-photosensitive resin component, antioxidizing agent, organic dye, sensitizer, sensitizer aid, plasticizer, thickener, dispersant, and antiprecipitating agent.

The solvent includes the terpene group such as α-, β-, γ-terpineol, ethylene glycol monoalkyl ether group, ethylene glycol dialkyl ether group, diethylene glycol monoalkyl ether group, and diethlene glycol dialkyl ether group. Among them, one kind may be independently used. Alternatively, among them, two or more kinds may be mixed and used.

The barrier rib paste according to present exemplary embodiment is a photosensitive paste having an alkali-developable property, as one example. Here, the alkali developable property means that, in a case where a negative mask is used at the time of exposure, in a state before exposed, it is dissolved with an alkaline water-based developing solution having a pH value of 9 to 14, but it is not dissolved with a neutral water-based developing solution having a pH value of 6 to 8. Meanwhile, in a state after exposed, it is not dissolved with the alkaline water-based developing solution having the pH value of 9 to 14 and the neutral water-based developing solution having the pH value of 6 to 8.

The non-photosensitive resin component includes a cellulose compound such as methyl cellulose or ethyl cellulose, and high-polymer polyether. In addition, the photosensitive monomer is a compound containing carbon-carbon unsaturated bond.

### (Drying of Barrier Rib Paste)

Then, the solvent in the barrier rib paste is removed in the baking oven. The baking oven includes the heater heating oven, reduced-pressure baking oven, and infrared baking oven. An atmosphere in the drying treatment may be the air or an inert gas. A drying temperature is about 80° C. to 200° C. A drying time is about 3 min to 30 min. A film thickness of the barrier rib paste decreases through the drying treatment. The film thickness of the barrier rib paste after dried is appropriately set within a range of 50 μm to 200 μm. The drying temperature and the drying time are appropriately set according to a kind and an amount of the solvent contained in the barrier rib paste. The above steps are preceding steps in FIG. 7.

### (Exposing)

In S21, the separate exposure is performed. The negative type photomask is used in the exposure process. The exposure apparatus may include the stepper exposure apparatus, the proximity exposure apparatus, and the like. The light-emitting device includes the excimer lamp, low-pressure mercury lamp, high-pressure mercury lamp, and the like.

A first barrier rib region is exposed to light through a first photomask on which a predetermined pattern is formed. The first photomask corresponds to first photomask 53 in FIG. 4. The first barrier rib electrode region corresponds to first exposure region 52a in FIG. 6. Then, a second barrier rib region is exposed to light through a second photomask on which a predetermined pattern is formed. The second photomask corresponds to second photomask 54 in FIG. 6. The second barrier rib region corresponds to second exposure region 52b in FIG. 6.

A wavelength of the light is set such that the photopolymerization initiator contained in the barrier rib paste reacts. It is about 250 nm to 450 nm in general. The region irradiated with the light, in the barrier rib paste is hardened.

### (Developing)

In S22, the barrier rib paste is developed. As a developing solution, the alkali developing solution is used, as one example. More specifically, it includes the sodium carbonate solution, potassium hydroxide solution, TMAH (tetramethyl ammonium hydroxide), and the like. When the developing solution is ejected to the barrier rib paste, the region irradiated with the light remains, and the region not irradiated with the light is removed. Finally, the region is cleaned by water to remove a stain attached on rear substrate 8.

### (Firing)

In S23, a barrier rib pattern is fired in the baking oven. As the baking oven, for example, the heater heating oven is used. An atmosphere in the firing treatment preferably contains oxygen to bake the resin. That is, the atmosphere may be the air. The barrier rib pattern is fired at a predetermined temperature in the baking oven. That is, the polymer in the barrier rib pattern is removed. In addition, the glass frit in the barrier rib pattern is softened. The softened glass frit is hardened after fired. Through the firing treatment, barrier rib 11 is formed on rear substrate 8.

### (Shape Measuring)

In S24, for example, a width of the barrier rib is measured by the image recognition device. The image recognition device may be the same device used in step S14. A line width of barrier rib 11 is measured in each region of the first barrier rib region and the second barrier rib region. Especially, it is preferably measured in the vicinity of connection part 52c. In addition, it is preferably measured in several positions.

### 4-3. Assembling Steps S31 to S32

### (Evaluation)

In S31, it is determined whether or not rear substrate 8 or front substrate 3 is rotated 180 degrees. More specifically, it is evaluated whether or not the widths of bus electrodes 4b and 5b and the width of barrier rib 11 in connection part 52c exceed a threshold value. In addition, as for rear substrate 8, it is preferably evaluated before phosphor layer 12 is formed. This is because the shape of barrier rib 11 can be easily evaluated. In addition, this is because the following step can be easily performed.

Hereinafter, S31 will be described in more detail.

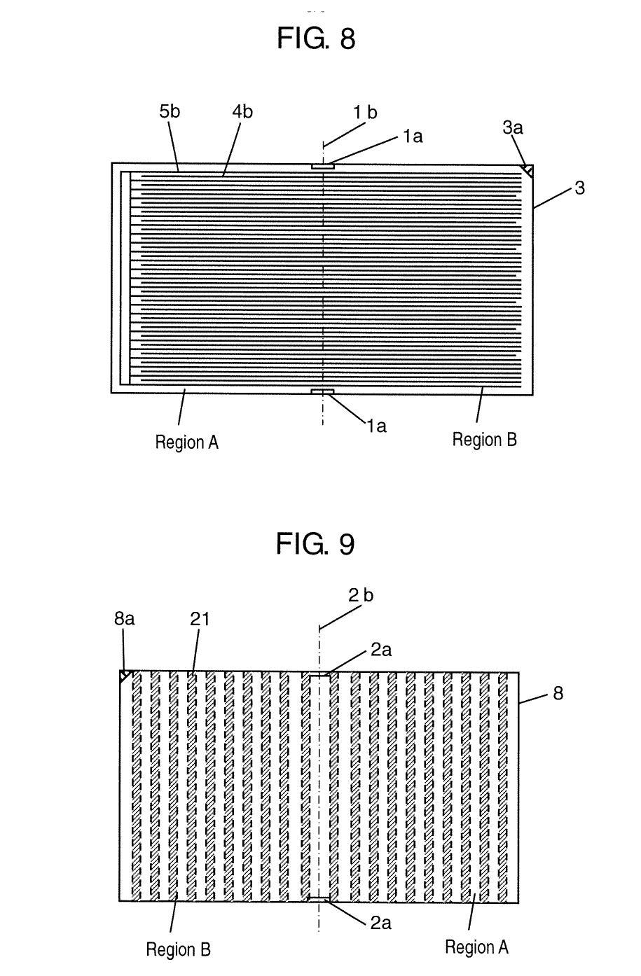

As shown in FIG. 8, alignment marks 1a are provided in upper and lower ends in centers of long sides of front substrate 3. Alignment mark 1a is a cross-shaped mark, as one example. In addition, alignment mark 1a may be formed at the same time as bus electrodes 4b and 5b are formed on front substrate 3. In addition, front substrate reference position 3a is provided in an upper right corner of front substrate 3. Left region A of connection part 1b in FIG. 8 corresponds to the first bus electrode region.

Right region B of connection part 1b corresponds to the second bus electrode region. In addition, connection part 1b corresponds to connection part 52c in FIG. 6.

In addition, as shown in FIG. 9, alignment marks 2a are provided in upper and lower ends in centers of long sides of rear substrate 8. Alignment mark 2a is a cross-shaped mark, as one example. In addition, alignment mark 2a may be formed at the same time as barrier rib 11 is formed on rear substrate 8. In addition, rear substrate reference position 8a is provided in an upper left corner of rear substrate 8. Left region B of connection part 2b in FIG. 9 corresponds to the first barrier rib region. Right region A of connection part 2b corresponds to the second barrier rib region. In addition, connection part 2b corresponds to connection part 52c in FIG. 6.

In addition, front substrate reference position 3a and rear substrate reference position 8a may have a configuration in which the region of front substrate 3 and/or rear substrate 8 is partially cut, or a configuration in which a mark is added. In addition, the positions of front substrate reference position 3a and rear substrate reference position 8a may be appropriately set.

(Arrangement in which Front Substrate Reference Position 3a and Rear Substrate Reference Position 8a Overlap with Each Other)

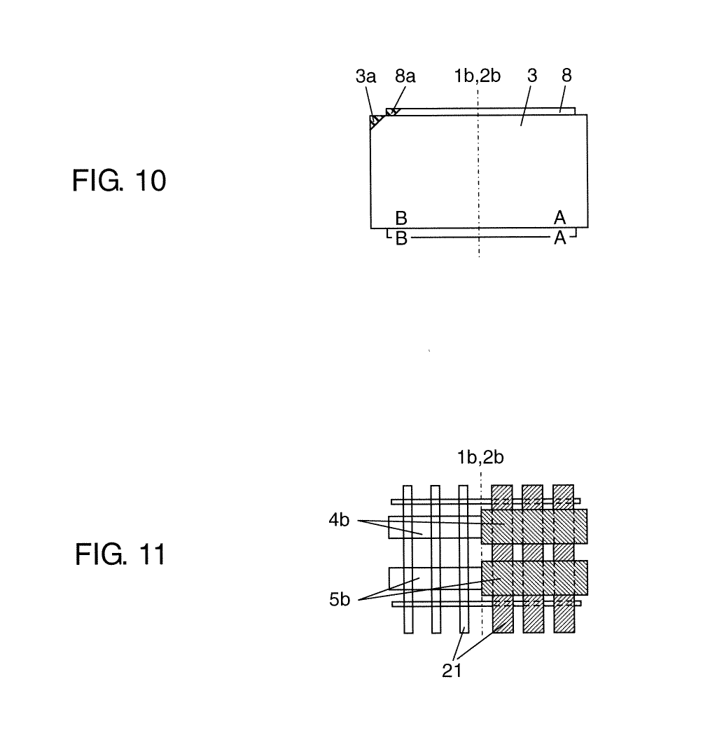

As shown in FIG. 10, it is assumed that front substrate 3 and rear substrate 8 are disposed so as to confront each other such that front substrate reference position 3a and rear substrate reference position 8a overlap with each other. Therefore, region A of front substrate 3 and region A of rear substrate 8 are disposed so as to confront each other. That is, region B of front substrate 3 and region B of rear substrate 8 are disposed so as to confront each other.

Furthermore, as shown in FIG. 11, it is assumed that the line widths of bus electrodes 4b and 5b and vertical barrier rib 21 differ between region A and region B.

The widths of bus electrodes 4b and 5b in region A of front substrate 3 are larger than the widths of bus electrodes 4b and 5b in region B thereof. Therefore, an aperture ratio of region A of front substrate 3 is smaller than an aperture ratio of region B thereof.

The width of vertical barrier rib 21 in region A of rear substrate 8 is larger than the width of vertical barrier rib 21 in region B thereof. Therefore, an aperture ratio of region A of rear substrate 8 is smaller than an aperture ratio of region B thereof.

Thus, in the case of the opposed arrangement as shown in FIG. 10, a value obtained by multiplying the aperture ratio of region A of front substrate 3 by the aperture ratio of region A of rear substrate 8 is smaller than a value obtained by multiplying the aperture ratio of region B of front substrate 3 by the aperture ratio of region B of rear substrate 8. Therefore, the left side of connection parts 1b and 2b is bright and the right side thereof is dark. Thus, a difference in brightness can be easily recognized in connection parts 1b and 2b and their vicinities.

(Arrangement in which Front Substrate Reference Position 3a and Rear Substrate Reference Position 8a are Diagonally Positioned)

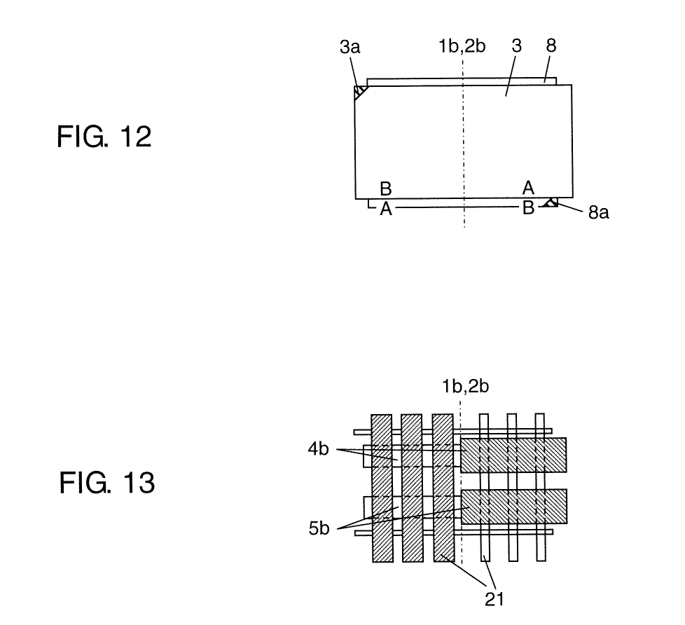

As shown in FIG. 12, rear substrate 8 is rotated 180 degrees and disposed so as to confront front substrate 3 such that front substrate reference position 3a and rear substrate reference position 8a are diagonally positioned. Therefore, region B of front substrate 3 and region A of rear substrate 8 are disposed so as to confront each other. That is, region A of front substrate 3 and region B of rear substrate 8 are disposed so as to confront each other.

Thus, as shown in FIG. 13, a big difference is not provided between a value obtained by multiplying the aperture ratio of region A of front substrate 3 by the aperture ratio of region B of rear substrate 8, and a value obtained by multiplying the aperture ratio of region B of front substrate 3 by the aperture ratio of region A of rear substrate 8. Thus, a difference in brightness is not likely to be recognized in connection parts 1b and 2b and their vicinities. That is, compared with the arrangement in which front substrate reference position 3a and rear substrate reference position 8a overlap with each other, the difference in brightness is not likely to be recognized in connection parts 1b and 2b and their vicinities.

As described above, the difference in brightness in connection parts 1b and 2b can be reduced by arrangement positions of the line widths of bus electrodes 4b and 5b, the line width of vertical barrier rib 21, front substrate 3, and rear substrate 8.

That is, in S31, the aperture ratios are found from the line widths of bus electrodes 4b and 5b and the line width of vertical barrier rib 21, and it is determined whether the first bus electrode region and the first barrier rib region are disposed so as to confront each other, or the first bus electrode region and the second barrier rib region are disposed so as to confront each other. In addition, as for the rear substrate 8, the aperture ratio thereof may be found after the line width of horizontal barrier rib 22 is measured. This is because calculation accuracy of the aperture ratio can be improved.

### (Rotation)

In S32, when it is evaluated that the value is the threshold value or more in S31, front substrate 3 or rear substrate 8 is rotated 180 degrees. In addition, when it is evaluated that the value is less than the threshold value in S31, S32 is not executed.

In addition, the brightness difference in connection parts 1b and 2b is likely to be recognized when its ratio exceeds about 1.5%. That is, it is preferable that front substrate 3 and rear substrate 8 are arranged such that the brightness difference is 1.5% or less. In general, a human eye has a high detection ability for an abrupt brightness difference. In other words, it cannot detect a case where the brightness moderately changes. When the abrupt change in brightness difference is generated in connection parts 1b and 2b, this is likely to be detected by the human eye.

Meanwhile, the region in which the abrupt brightness difference is recognized differs depending on the size of PDP 100. That is, as PDP 100 becomes large, the region in which the abrupt brightness difference is recognized becomes large. Studies by inventors have found that as for diagonal 150-inch PDP 100 (image display region is 340 cm×180 cm), the brightness difference is likely to be recognized when it is generated in a region positioned 3.0 cm or less away from connection parts 1b and 2b toward right and left sides. That is, when diagonal 150-inch PDP 100 is produced, it is preferable that the widths of bus electrodes 4b and 5b and the width of vertical barrier rib 21 are measured in the region positioned 3.0 cm or less away from connection parts 1b and 2b toward the right and left directions. In addition, when diagonal 100-inch PDP 100 (image display region is 230 cm×130 cm) is produced, it is preferable that the widths of bus electrodes 4b and 5b and the width of vertical barrier rib 21 are measured in a region positioned 2.1 cm or less away from connection parts 1b and 2b toward the right and left directions. In addition, when diagonal 85-inch PDP 100 (image display region is 190 cm×100 cm) is produced, it is preferable that the widths of bus electrodes 4b and 5b and the width of vertical barrier rib 21 are measured in a region positioned 1.8 cm or less away from connection parts 1b and 2b toward the right and left directions. In addition, measurement positions preferably face each other when front substrate 3 and rear substrate 8 are disposed so as to confront each other. This is because more accurate evaluation can be made in S31.

Furthermore, the studies by the inventors found that the threshold value of the line width depends on a pixel size. In addition, the pixel size means a size of one pixel composed of three discharge cells such as a discharge cell emitting red light, a discharge cell emitting green light, and a discharge cell emitting blue light. The one pixel is roughly square in shape. In a case of a pixel having one side of 830 μm, when the line width difference is 3 μm or more in connection parts 1b and 2b, the brightness difference reaches 1.5%. In a case of a pixel having one side of 980 μm, when the line width difference is 4.2 μm or more in connection parts 1b and 2b, the brightness difference reaches 1.5%. In a case of a pixel having one side of 1180 μm, when the line width difference is 6 μm or more in connection parts 1b and 2b, the brightness difference reaches 1.5%. Therefore, the threshold value is preferably changed depending on the pixel size of PDP 100 to be produced.

In addition, PDP 100 can be produced without setting the threshold value. That is, a first difference value is found by subtracting the value obtained by multiplying the aperture ratio of the second electrode region by the aperture ratio of the second barrier rib region, from the value obtained by multiplying the aperture ratio of the first electrode region by the aperture ratio of the first barrier rib region in the case where the first electrode region and the first barrier rib region are disposed so as to confront each other. Then, a second difference value is found by subtracting the value obtained by multiplying the aperture ratio of the second electrode region by the aperture ratio of the first barrier rib region, from the value obtained by multiplying the aperture ratio of the first electrode region by the aperture ratio of the second barrier rib region in the case where the first electrode region and the second barrier rib region are disposed so as to confront each other. When an absolute value of the first difference value is smaller than an absolute value of the second difference value, the first electrode region and the first barrier rib region are disposed so as to confront each other. When the absolute value of the first difference value is greater than the absolute value of the second difference value, the first electrode region and the second barrier rib region are disposed so as to confront each other. By the above method, PDP 100 having a smaller brightness difference can be produced.

### 5. Evaluation of Brightness Difference in PDP Device

An evaluation result in producing diagonal 150-inch PDP 100 is shown.

### 5-1. Measurement of Line Width Difference

One front substrate 3 and one rear substrate 8 are experimentally produced by the production method in present exemplary embodiment.

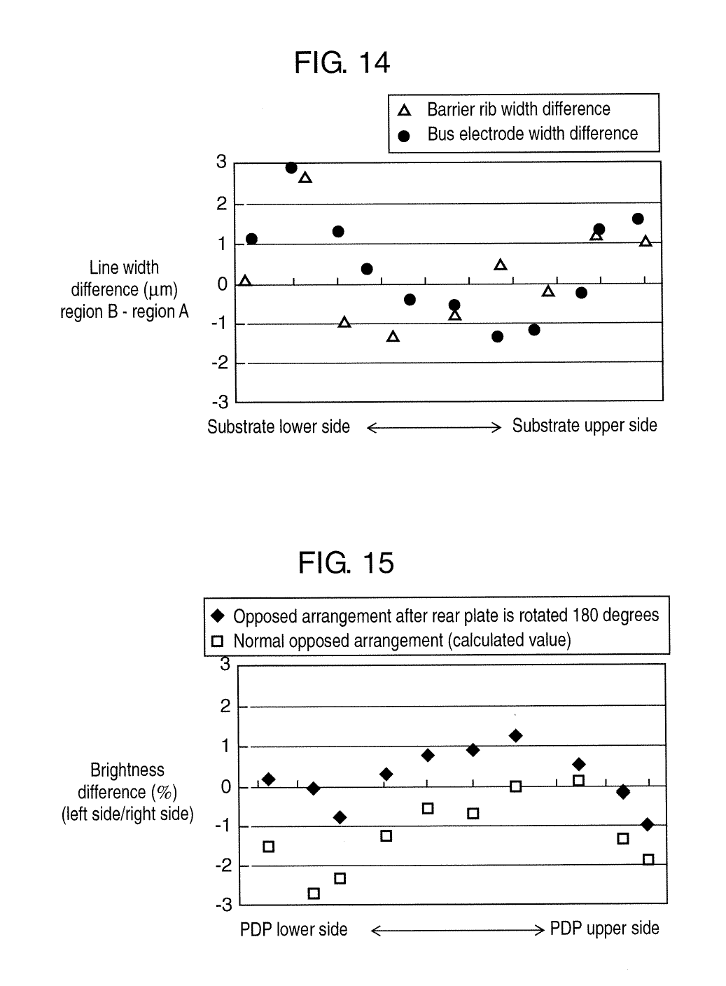

A difference in line width of vertical barrier rib 21 shown in FIG. 14 (shown by a symbol of Δ in the drawing) is a difference value between the line width of region B in the vicinity of connection part 2b, and the line width of region A in the vicinity of connection part 2b. A difference in line width of bus electrodes 4b and 5b (shown by a symbol of in the drawing) is a difference value between the line width of region B in the vicinity of connection part 1b, and the line width of region A in the vicinity of connection part 1b.

A substrate lower side in FIG. 14 means a lower side of front substrate 3 in FIG. 8, and a lower side of rear substrate 8 in FIG. 9. A substrate upper side in FIG. 14 means an upper side of front substrate 3 in FIG. 8, and an upper side of rear substrate 8 in FIG. 9. That is, FIG. 14 shows a result measured at several positions in the vicinity of connection parts 1b and 2b.

In FIG. 14, when a value shown in a vertical axis is a positive, it means that the line width of region B is larger than the line width of region A in the vicinities of connection parts 1b and 2b. Meanwhile, when it is a negative, it means that the line width of region A is smaller than the line width of region B. In addition, a line width difference in FIG. 14 is an average value of the plurality of line width differences.

As shown in FIG. 14, the line widths of bus electrodes 4b and 5b in region B are larger than those in region A on the substrate lower and upper sides. A maximum value of the line width difference of bus electrode 4b and 5b is about 3.0 μm. The line width of vertical barrier rib 21 shows the similar tendency. A maximum value of the line width difference of vertical barrier rib 21 is about 3.0 μm.

### 5-2. Brightness Evaluation

A normal opposed position (shown by a symbol of □ in the drawing) in FIG. 15 is a comparison example. That is, a value shown in FIG. 15 is a brightness difference (calculated value) shown in FIG. 15 when it is assumed that region A of front substrate 3 and region A of rear substrate 8 are disposed so as to confront each other.

Meanwhile, the opposed arrangement in which the rear plate is rotated 180 degrees (shown by a symbol of ♦ in the drawing) in FIG. 15 is a working example. That is, rear substrate 8 is rotated 180 degrees so as to be symmetrical with respect to a point and disposed so as to confront front substrate 3. It is an actual measured value of PDP 100 produced such that region A of front substrate 3 and region B of rear substrate 8 are disposed so as to confront each other.

In addition, a PDP upper side and a PDP lower side shown in FIG. 15 are the same in meaning as those in FIG. 14. A vertical axis shown in FIG. 15 shows a value obtained by dividing the brightness of the left region of connection parts 1b and 2b by the brightness of the right region of connection parts 1b and 2b, and subtracting 1 from it. For example, when there is no brightness difference between the left region and right region of connection parts 1b and 2b, the brightness of left region/brightness of right region is equal to 1, so that the brightness difference becomes 0%.

The calculated brightness difference in the comparison example reaches a maximum value of 2.0% in the upper side of PDP 100. In addition, it reaches a maximum value of 2.8% in the lower side of PDP 100. That is, the brightness difference exceeds 1.5%. Thus, in the comparison example, the brightness difference is likely to be recognized in connection parts 1b and 2b and their vicinities on the lower side and the upper side of PDP 100. That is, it is thought that a display quality of PDP device is reduced because the brightness difference is recognized.

Meanwhile, the brightness difference in the working example can be suppressed to 1.2% or less. That is, the brightness difference is not likely to be recognized in connection parts 1b and 2b and their vicinities. Thus, a display quality when PDP 100 is lit up is prevented from being reduced.

Therefore, according to the production method in present exemplary embodiment, in the case where the diagonal 150-inch PDP 100 is produced, as one example, when the line width difference of bus electrodes 4b and 5b and the line width difference of barrier rib 11 exceed 3.0 μm in connection parts 1b and 2b and between region A and region B as their vicinities, rear substrate 8 is rotated 180 degrees so as to be symmetrical with respect to a point and disposed so as to opposed to front substrate 3.

### 6. Conclusion

The method for producing PDP 100 according to present exemplary embodiment includes the following steps. Each of bus electrodes 4b and 5b is formed by separately exposing the electrode paste layer provided on front substrate 3 and containing the photosensitive component, in the two regions such as region A serving as the first electrode region, and region B serving as the second electrode region divided by the center of front substrate 3. Barrier rib 11 is formed by separately exposing the barrier rib paste layer provided on rear substrate 8 and containing the photosensitive component, in the two regions such as region A serving as the first barrier rib region, and region B serving as the second barrier rib region divided by the center of rear substrate 8. The aperture ratio of the first electrode region and the aperture ratio of the second electrode region are found in connection part 1b provided in the vicinity of the boundary between the first electrode region and the second electrode region. The aperture ratio of the first barrier rib region and the aperture ratio of the second barrier rib region are found in connection part 2b provided in the vicinity of the boundary between the first barrier rib region and the second barrier rib region. In the case where the first electrode region and the first barrier rib region are disposed so as to confront each other, the first difference value is found by subtracting the value obtained by multiplying the aperture ratio of the second electrode region by the aperture ratio of the second barrier rib region, from the value obtained by multiplying the aperture ratio of the first electrode region by the aperture ratio of the first barrier rib region. In the case where the first electrode region and the second barrier rib region are disposed so as to confront each other, the second difference value is found by subtracting the value obtained by multiplying the aperture ratio of the second electrode region by the aperture ratio of the first barrier rib region, from the value obtained by multiplying the aperture ratio of the first electrode region by the aperture ratio of the second barrier rib region. In the case where the absolute value of the first difference value is smaller than the absolute value of the second difference value, the first electrode region and the first barrier rib region are disposed so as to confront each other.

The method in present exemplary embodiment can provide PDP 100 in which the brightness difference in connection parts 1b and 2b for the separate exposure and their vicinities is not likely to be recognized. Thus, the display quality when PDP 100 is lit up is prevented from being reduced.

In addition, the step of finding the aperture ratio of the first electrode region and the aperture ratio of the second electrode region in the vicinity of the boundary between the first electrode region and the second electrode region, and the step of finding the aperture ratio of the first barrier rib region and the aperture ratio of the second barrier rib region in the vicinity of the boundary between the first barrier rib region and the second barrier rib region are preferably performed such that the aperture ratio of the first electrode region and the aperture ratio of the second electrode region are found and the aperture ratio of the first barrier rib region and the aperture ratio of the second barrier rib region are found in the overlapped positions provided after the front substrate 3 and rear substrate 8 are disposed so as to confront each other. This is because the brightness difference can be more accurately calculated in PDP 100.

In addition, the configuration, the material, the device, and the like shown in present exemplary embodiment are only illustrative. Thus, the illustrated configuration does not limit the present invention.

### INDUSTRIAL APPLICABILITY

The technique disclosed here can provide a large-screen PDP capable of preventing its display quality from being reduced. Thus, it is useful for a large-screen display device.

### REFERENCE MARKS IN THE DRAWINGS

1 front plate
1a, 2a alignment mark
1b, 2b, 52c connection part
2 rear plate
3 front substrate
4 scan electrode
5 sustain electrode
4a, 5a transparent electrode
4b, 5b bus electrode
6 dielectric layer
7 protective layer
9 base dielectric layer
10 data electrode
11 barrier rib
12 phosphor layer
21 vertical barrier rib
22 horizontal barrier rib
51 substrate
52 photosensitive material layer
53 first photomask
54 second photomask
55 opening
100 PDP

1. A method for producing a plasma display panel, the method comprising:
forming a bus electrode by separately exposing an electrode paste layer provided on a front substrate and containing a photosensitive component, in two regions such as a first electrode region, and a second electrode region divided at a center of the front substrate;
forming a barrier rib by separately exposing a barrier rib paste layer provided on a rear substrate and containing a photosensitive component, in two regions such as a first barrier rib region, and a second barrier rib region divided at a center of the rear substrate;
finding an aperture ratio of the first electrode region and an aperture ratio of the second electrode region in a vicinity of a boundary between the first electrode region and the second electrode region;
finding an aperture ratio of the first barrier rib region and an aperture ratio of the second barrier rib region in a vicinity of a boundary between the first barrier rib region and the second barrier rib region;
finding a first difference value by subtracting a value obtained by multiplying the aperture ratio of the second electrode region by the aperture ratio of the second barrier rib region, from a value obtained by multiplying the aperture ratio of the first electrode region by the aperture ratio of the first barrier rib region, in a case where the first electrode region and the first barrier rib region are disposed so as to confront each other;
finding a second difference value by subtracting a value obtained by multiplying the aperture ratio of the second electrode region by the aperture ratio of the first barrier rib region, from a value obtained by multiplying the aperture ratio of the first electrode region by the aperture ratio of the second barrier rib region, in a case where the first electrode region and the second barrier rib region are disposed so as to confront each other;
disposing the first electrode region and the first barrier rib region so as to confront each other, in a case where an absolute value of the first difference value is smaller than an absolute value of the second difference value; and
disposing the first electrode region and the second barrier rib region so as to confront each other, in a case where the absolute value of the first difference value is greater than the absolute value of the second difference value.

2. The method for producing the plasma display panel according to claim 1, wherein
the step of finding the aperture ratio of the first electrode region and the aperture ratio of the second electrode region in the vicinity of the boundary between the first electrode region and the second electrode region, and the step of finding the aperture ratio of the first barrier rib region and the aperture ratio of the second barrier rib region in the vicinity of the boundary between the first barrier rib region and the second barrier rib region are performed in such a manner that the aperture ratio of the first electrode region and the aperture ratio of the second electrode region are found and the aperture ratio of the first barrier rib region and the aperture ratio of the second barrier rib region are found at overlapped positions provided after the front substrate and the rear substrate are disposed so as to confront each other.

3. The method for producing the plasma display panel according to claim 2, wherein
the step of finding the aperture ratio of the first electrode region and the aperture ratio of the second electrode region in the vicinity of the boundary between the first electrode region and the second electrode region further comprises a step of finding aperture ratios of a plurality of first electrode regions and aperture ratios of a plurality of second electrode regions, and the step of finding the aperture ratio of the first barrier rib region and the aperture ratio of the second barrier rib region in the vicinity of the boundary between the first barrier rib region and the second barrier rib region further comprises a step of finding aperture ratios of a plurality of first barrier rib regions and aperture ratios of a plurality of second barrier rib regions.

4. The method for producing the plasma display panel according to claim 1, wherein
the step of finding the aperture ratio of the first electrode region and the aperture ratio of the second electrode region in the vicinity of the boundary between the first electrode region and the second electrode region further comprises a step of measuring a width of the bus electrode.

5. The method for producing the plasma display panel according to claim 1, wherein
the step of finding the aperture ratio of the first barrier rib region and the aperture ratio of the second barrier rib region in the vicinity of the boundary between the first barrier rib region and the second barrier rib region further comprises a step of measuring a width of the barrier rib.

6. A plasma display panel produced by a method for producing a plasma display panel, the method comprising:
forming a bus electrode by separately exposing an electrode paste layer provided on a front substrate and containing a photosensitive component, in two regions such as a first electrode region, and a second electrode region divided at a center of the front substrate;
forming a barrier rib by separately exposing a barrier rib paste layer provided on a rear substrate and containing a photosensitive component, in two regions such as a first barrier rib region, and a second barrier rib region divided at a center of the rear substrate;
finding an aperture ratio of the first electrode region and an aperture ratio of the second electrode region in a vicinity of a boundary between the first electrode region and the second electrode region;
finding an aperture ratio of the first barrier rib region and an aperture ratio of the second barrier rib region in a vicinity of a boundary between the first barrier rib region and the second barrier rib region;
finding a first difference value by subtracting a value obtained by multiplying the aperture ratio of the second electrode region by the aperture ratio of the second barrier rib region, from a value obtained by multiplying the aperture ratio of the first electrode region by the aperture ratio of the first barrier rib region, in a case where the first electrode region and the first barrier rib region are disposed so as to confront each other;
finding a second difference value by subtracting a value obtained by multiplying the aperture ratio of the second electrode region by the aperture ratio of the first barrier rib region, from a value obtained by multiplying the aperture ratio of the first electrode region by the aperture ratio of the second barrier rib region, in a case where the first electrode region and the second barrier rib region are disposed so as to confront each other;
disposing the first electrode region and the first barrier rib region to confront each other, in a case where an absolute value of the first difference value is smaller than an absolute value of the second difference value; and
disposing the first electrode region and the second barrier rib region so as to confront each other, in a case where the absolute value of the first difference value is greater than the absolute value of the second difference value.
